(19) United States
(12) Patent Application Publication
(10) Pub. No.: US 2019/0264846 A1
(43) Pub. Date: Aug. 29, 2019

(54) Clip Having A Thermal Insulation Layer

(71) Applicant: NORMA Germany GmbH, Maintal (DE)

(72) Inventor: Marvin Hoppe, Schöneck (DE)

(21) Appl. No.: 16/310,683

(22) PCT Filed: May 29, 2017
(86) PCT No.: PCT/EP2017/062862

§ 371 Date: Dec. 17, 2018

(30) Foreign Application Priority Data
Jun. 17, 2016 (DE) 10 2016 111 117.1

(51) Int. Cl. F16L 23/08; F01N 13/14

(52) U.S. Cl. CPC F16L 23/08; F01N 13/14

(57) ABSTRACT

The disclosure relates to a clip, in particular a ring clip, that includes a clip band, which has a base and two radially inwardly directed flanks, and at least one clamping device, wherein the clip has an inner face and an outer face. According to the disclosure, the outer face of the clip has at least a partial thermal insulation layer.

### INTRODUCTION

The disclosure relates to a clip.

Clips, in particular ring clips, are used, for example, for connecting two components, wherein each of the components to be connected has a radially outwardly directed flange on the end side. For the connection, typically the two flanges are brought into contact and a clip is positioned thereon, so that the inner faces of the flanks of a clip bear against the rear faces of the flanges. The clamping and fastening of the clip and thus the connection take place subsequently by means of the clamping device.

A clip which is suitable therefor is disclosed, for example, in DE 10 2009 039 862 B4.

Pipelines which are connected to other components by means of clips are also fitted, for example, in the engine compartments of passenger motor vehicles and trucks. In the context of more efficient and more environmentally friendly engines, high temperatures of the exhaust gases are often desirable during the post-treatment, so that the exhaust gas pipes frequently have to be thermally insulated. In particular, long exhaust gas systems are sometimes present in truck engines, which would lead to significant heat loss without corresponding thermal insulation. An example of a thermal insulation of pipelines is disclosed in DE 10 2014 100 296 A1.

However, the connecting elements used, in particular clips, frequently have no thermal insulation whatsoever so that significant heat losses occur in these regions. Additionally, heat-sensitive components may be damaged by a high level of heat dissipation from the connecting elements.

### SUMMARY

It is, therefore, an object of the disclosure to remedy the drawbacks of the prior art and to provide a clip which has good thermal insulation relative to its surroundings. Additionally, the connecting element is designed to be produced in a simple and cost-effective manner.

In a clip, in particular a ring clip, comprising a clip band which has a base and two radially inwardly directed flanks, and at least one clamping device, wherein the clip has an inner face and an outer face, the disclosure provides that the outer face of the clip has at least partially a thermal insulation layer.

Such a thermal insulation layer on the outer face of the clip permits a reduction in the heat loss. If, in particular, the pipes or other components to be connected also have thermal insulation, the heat loss, for example of an exhaust gas system, may be significantly reduced as a whole, whereby an exhaust gas post-treatment may be carried out more efficiently and thus more environmentally friendly engines may be provided.

Additionally, a clip with an insulation layer according to the disclosure ensures that such connecting arrangements may also be installed closer to heat-sensitive components, enabling a space-saving engine design.

The clip band of the clip in this case, in an embodiment, has a trapezoidal shape which is achieved by the two flanks being inclined in opposing directions. Alternatively, the clip band of the clip has a V-shape or U-shape. Depending on the shape of the flanges of the components to be connected, corresponding profiles of the clips are required, said profiles being determined by the shape of the clip band.

In an embodiment of the clip according to the disclosure, the outer face of the base or the outer face of the flanks has an insulation layer. In particular, the outer faces of both elements, the base and the flanks, have a thermal insulation layer. As a result, an optimal thermal insulation of the connecting element relative to the surroundings may be achieved.

If, in particular, a space-saving connecting arrangement is intended to be permitted without a substantial impact on the heat loss, it may be sufficient if merely the surfaces which face a further heat-sensitive component have an insulation layer.

In an embodiment, the outer face of the clip is coated with the thermal insulation layer, wherein adhesive forces act between the outer face of the clip and the thermal insulation layer. Such a coating which is based on adhesive forces may be applied by means of coating methods, without separate components having to be produced and mounted. This shortens and simplifies the production process, whereby the production costs may also be reduced.

In an embodiment, the outer face of the clip is substantially entirely coated with the insulation layer. By almost entirely coating the outer face with the insulation layer, a suitable insulation of the connecting element relative to the surroundings is ensured. Additionally, the insulation effect is improved and thus the heat loss and the thermal radiation on the connecting element is reduced.

It is suitable, in an embodiment, if neither the inner face of the clip, against which the flanges of the pipes or other components bear after being mounted, nor the clamping device, which serves for clamping and closing the clip, has an insulation layer. As a result, full functionality of the clip may be ensured.

In order to simplify further the production of a clip with a thermal insulation layer, it is provided in an embodiment that the inner face of the clip has at least partially a thermal insulation layer. In particular, the inner face of the clip is completely coated with the thermal insulation layer. As a result, an additionally improved thermal insulation of the clip is possible. Additionally, the clip, in particular the inner face and the outer face of the clip, may be coated with the thermal insulation layer during production without specific regions having to be left blank.

In an embodiment, the clip band of the clip comprises at least two clip portions. These two clip portions are connected, for example, by a joint portion. The joint portion may be formed, for example, from an indentation between two clip portions or from a connecting element which connects two clip portions together. The total number of the clip portions connected together forms the clip band.

An arrangement with a plurality of clip portions enables the clip simply to be bent open for mounting. If the clip is pushed onto the flanges, positioning may be carried out more easily, the wider the clip is able to be opened. This is sometimes influenced by the number of clip portions and joint portions.

In a further embodiment, the clip comprises three clip portions. This ensures a more flexible mounting of the clip.

Preferably the clip comprises a cover band which is connected by a material connection to an outer surface of the clip band. In this case, the outer surface of the clip band and a radially internal surface of the cover band are connected together, in particular welded. This cover band permits an additional stabilizing of the clip band and additionally effects a reduction of the thermal conduction and the thermal radiation to the surroundings.

In an embodiment, at least one radially external surface of the cover band is coated with the thermal insulation layer. By means of this embodiment, the heat loss, for example of an exhaust gas system, is reduced. Moreover, the thermal radiation in this region is reduced, whereby surrounding heat-sensitive parts are protected.

In an embodiment, the thermal insulation layer comprises a material with a low thermal conductivity, which in particular is lower than a thermal conductivity of the clip band and/or the cover band. The lower the thermal conductivity of a material, and thus of the thermal insulation layer, the greater the thermally insulating effect. The clip band and/or the cover band are produced, for example, from stainless steel, steel alloys and/or galvanized steel. If a material with a low thermal conductivity is used for the thermal insulation layer, the thermal conduction and thermal radiation may be reduced in an optimal manner.

In an embodiment, the material has a thermal conductivity of less than 50 W/mK. In a particular example, the material has a thermal conductivity which is less than 20 W/mK, in particular less than 10 W/mK. As a result, a good thermally insulating effect may be ensured.

In an embodiment, the thermal insulation layer comprises a ceramic material. Ceramics have lower thermal conductivities so that a very good insulating effect may be achieved. Additionally, a ceramic insulation layer is particularly stable relative to friction and other effects of wear, so that a permanent insulating effect may be ensured. In particular, in pipe connections which are subjected to continuous movements and vibrations, such as for example in an engine compartment, a friction-resistant outer layer in the form of the thermal insulation layer is important.

The thermal insulation layer, in an embodiment, comprises ceramics, such as for example zirconium dioxide, calcium oxide, yttrium (III) oxide, aluminum (III) oxide or magnesium oxide or mixtures thereof. In particular, thermal insulation layer comprises a ceramic mixture, in particular zirconium dioxide/calcium oxide, zirconium dioxide/yttrium (III) oxide or aluminum (III) oxide/magnesium oxide.

A thermal insulation layer which comprises a ceramic material may be applied, for example, by means of thermal spraying onto the outer face of the clip. A possible method thereof is atmospheric plasma spraying, wherein a ceramic powder or powder mixture is supplied to a plasma flame, fused thereon and applied to the surface which has been pretreated immediately before, for example sand-blasted.

In an embodiment, the clip comprises two clamping devices. These clamping devices may comprise, for example, a screw with a screw head and a counter screw connection which connects together and tightens two opposing ends of the clip band.

If two clamping devices are provided, for example on opposing sides in the circumferential direction of the clip, the clip may be fully opened which significantly facilitates and accelerates the mounting of the clip. Additionally, with at least two clip portions the two clamping devices and the clip band may be clamped together more uniformly.

In an embodiment, the thermal insulation layer has a thickness of 0.1 to 3 mm. As a result, an optimal thermal insulation of the clip relative to the surroundings may be ensured, whereby the heat loss from, for example, an exhaust gas system and the heat radiation in this region may be reduced. Additionally, surrounding heat-sensitive parts are also protected.

### BRIEF DESCRIPTION OF THE FIGURES

Further features, details and advantages of the disclosure are disclosed in the wording of the clams and in the following description of exemplary embodiments, with reference to the drawings, in which:

FIG. 1 shows an embodiment of a clip,

FIG. 2 shows an alternative embodiment of a clip,

FIG. 3a shows a cross section of a clip,

FIG. 3b shows a cross section of an alternative clip,

FIG. 3c shows a cross section of an alternative clip,

FIG. 3d shows a cross section of an alternative clip.

### DETAILED DESCRIPTION

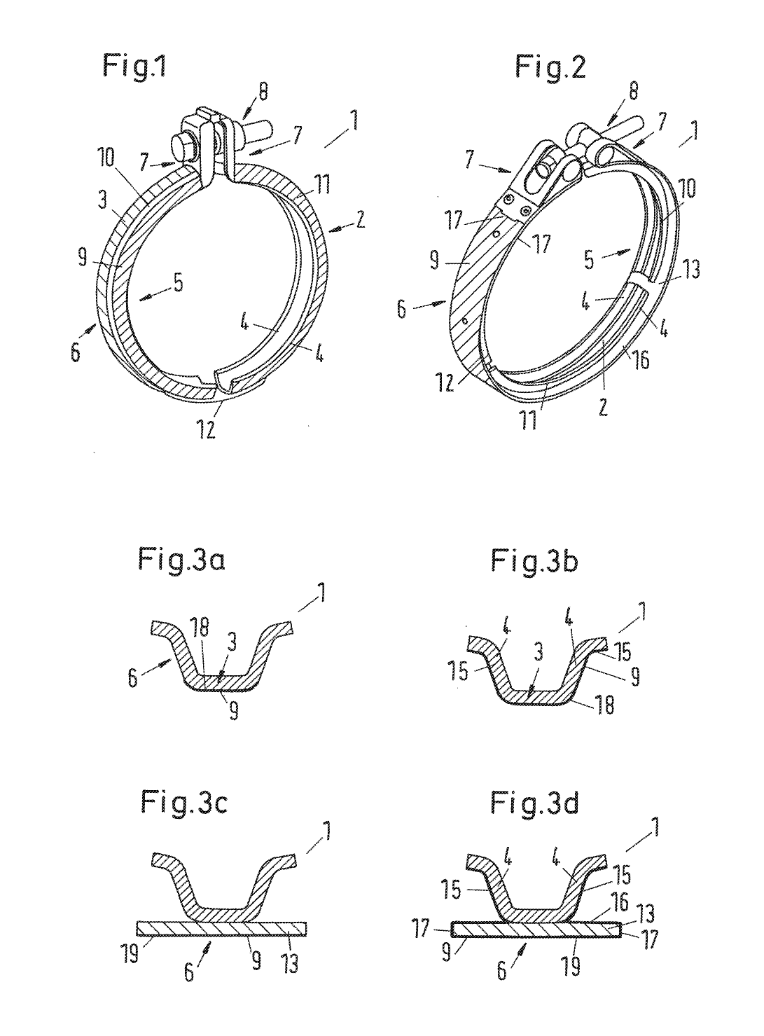

FIG. 1 shows a clip 1 according to an embodiment with a clip band 2, which has a base 3 and two radially inwardly directed flanks 4. In the embodiment shown here, the clip band 2 has a trapezoidal profile. The clip 1 has an inner face 5 which is formed by the inner face of the base 3 and the flanks 4, and an outer face 6 which is formed by the outer face of the base 3 and the flanks 4. The ends 7 of the clip band 2 are connected together, clamped and fastened via a clamping device 8. In the example shown here the clamping device 8 has a screw with a screw head and a screw connection. The outer face 6 of the clip 1 has a thermal insulation layer 9 which in this case covers both the flanks 4 and the base 3. Here the thermal insulation layer is a non-positive coating of the outer face 6 of the clip 1.

The embodiment shown in FIG. 1 has two clip portions 10, 11 which are connected together via a joint portion 12.

In FIG. 2 an alternative embodiment of the clip is shown. The clip 1 has a cover band 13 which is connected to a radially external surface of the clip band 2. A material connection is produced by means of welding. The clip band 2 has three clip portions 10, 11, 14.

Since the cover band 13 forms the outer face 6 of the clip 1, this cover band is at least partially coated with a thermal insulation layer 9. For example, the thermal insulation layer 9 consists of a ceramic material. Neither the ends 7 of the clip band 2 with the clamping device 8 nor the inner face 5 of the clip 1 have this thermal insulation layer 9.

In order to permit a simple production of the clip 1 with a thermal insulation layer 9 on the outer face 6 of the clip 1, it may also be provided that in addition to the cover band 13 the respective outer face 15 of the flanks 4 of the clip band also has a thermal insulation layer 9. Additionally, the free regions of the radially internal surface 16 of the cover band 13 and the lateral surfaces 17 of the cover band 13 may also be coated with the thermal insulation layer 9. These features are not shown here.

FIGS. 3a to 3d show cross sections of clips 1. The profile of the clip 1 is shown here as a trapezoidal profile. The embodiments shown by way of example, however, are able to be transferred to any other profile of a clip 1.

FIG. 3a shows a cross section of a clip 1 with a thermal insulation layer 9 on the outer face 6 of the clip 1, in this case exclusively the outer face 18 of the base 3 is coated.

FIG. 3b shows a cross section of a clip 1 with a thermal insulation layer 9 on the outer face 18 of the base 3 and the outer face 15 of the flanks 4. This embodiment is able to be produced in a particularly simple and cost-effective manner.

FIG. 3c shows a cross section of a clip 1 with a thermal insulation layer 9 on the outer face 6 of the clip 1, wherein the outer face 6 of the clip 1 is formed by the cover band 13. In the embodiment shown here, exclusively the radially external surface 19 of the cover band 13 has a thermal insulation layer 9.

FIG. 3d also shows a cross section of a clip 1 with a thermal insulation layer 9 on the outer face 6 of the clip 1. Here in addition to the radially external surface 19 of the cover band 13, the free regions of the radially internal surface 16 of the cover band 13, the lateral surfaces 17 of the cover band 13 and the two outer faces of the flanks 4 are also coated with a thermal insulation layer 9.

The invention is not limited to one of the embodiments described above but is able to be modified in many different ways.

All of the features and advantages disclosed in the claims, the description and the drawings, including structural details, spatial arrangements and method steps, may be essential to the invention both per se and also in very different combinations.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Clip

2 Clip band

3 Base

4 Flanks

5 Inner face of clip 1

6 Outer face of clip 1

7 Ends of clip band 2

8 Clamping device

9 Thermal insulation layer

10 Clip portion

11 Clip portion

12 Joint portion

13 Cover band

14 Clip portion

15 Outer face of flanks 4

16 Radially internal surface of cover band 13

17 Lateral surfaces of cover band 13

18 Outer face of base 3

19 Radially external surface of cover band 13

1. A clip, in particular ring clip, comprising a clip band which has a base and two radially inwardly directed flanks, and at least one clamping device, wherein the clip has an inner face and an outer face, and wherein the outer face of the clip at least partially has a thermal insulation layer.

2. The clip as claimed in claim 1, wherein the outer face of the clip is coated with the thermal insulation layer, wherein adhesive forces act between the outer face of the clip and the thermal insulation layer.

3. The clip as claimed in claim 1, wherein the clip band of the clip comprises at least two clip portions.

4. The clip as claimed in claim 1, wherein the clip comprises a cover band which is connected by a material connection to the outer surface of the clip band.

5. The clip as claimed in claim 4, wherein at least one radial outer surface of the cover band is coated with the thermal insulation layer.

6. The clip as claimed in claim 4, wherein the thermal insulation layer comprises a material with a thermal conductivity that is lower than a thermal conductivity of the clip band and/or the cover band.

7. The clip as claimed in claim 6, wherein the material of the thermal insulation layer has a thermal conductivity which is less than 20 W/mK, in particular less than 10 W/mK.

8. The clip as claimed in claim 1, wherein the thermal insulation layer comprises a ceramic material.

9. The clip as claimed in claim 1, wherein the clip comprises two clamping devices.

10. The clip as claimed in claim 1, wherein the thermal insulation layer has a thickness of that ranges approximately between 0.1 mm to 3 mm.
